(19) United States
(12) Patent Application Publication
(10) Pub. No.: US 2017/0142374 A1
(43) Pub. Date: May 18, 2017

(54) REMOTE MONITORING DEVICE, METHOD OF USE AND BUSINESS METHODS THEREFORE

(71) Applicant: BRIAN J. BERG, FREELAND, MI (US)

(72) Inventor: BRIAN J. BERG, FREELAND, MI (US)

(21) Appl. No.: 15/332,783

(22) Filed: Oct. 24, 2016

Related U.S. Application Data
(60) Provisional application No. 62/245,836, filed on Oct. 23, 2015.

(51) Int. Cl. H04N 7/18; H04N 5/225; G06Q 30/02; G08B 13/196; H04N 5/232; G06Q 50/26; G06K 9/00; H04N 5/76

(52) U.S. Cl. CPC H04N 7/183; H04N 7/185; G06K 9/00771; H04N 7/181; H04N 5/2252; H04N 5/76; G08B 13/19656; H04N 5/23216; H04N 5/23206; G08B 13/19632; G08B 13/1963; G08B 13/19621; G08B 13/19619; G08B 13/19684; G08B 13/19665; G06Q 50/265; G06Q 30/0279

(57) ABSTRACT

A new and effective law enforcement multiplier device with video, speakers and full analytics and an entire system is installed and constantly monitored in real time to displace and deter crime, rather than merely recording video of crimes to be reviewed at a later date. Also disclosed is a method of using the device and system as well as a business method for fund raising to pay for the multiplier device. The multiplier device includes a box containment with crime fighting equipment therein to be mounted on a pole near a high crime area, and providing live video feed back to a central processing station where crime analysts constantly watch multiple monitors displaying the live video feed. If criminal activity is viewed by the crime analyst, the analyst can shout out to the criminal right then and there, and they can alert law enforcement, to dispatch law-enforcement to address the criminals. The crime analysts are preferably volunteers that are certified by the private company providing the devices, and the business method is novel because it supplements the police by coordinating a full service organization to utilize volunteers and donations from citizens and local businesses to pay for the crime-fighting devices, as well as monitoring the video feeds from those devices in real time, thereby multiplying the effort and displacing and deterring more crime.

### CROSS-REFERENCE TO RELATED APPLICATIONS

This application claims the benefit under 35 U.S.C. 119(e) of U.S. Provisional Application No. 62/245,836 filed on Oct. 23, 2015.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM (EFS WEB)

Not Applicable

### STATEMENT REGARDING PRIOR DISCLOSURES BY THE INVENTOR OR A JOINT INVENTOR

Not Applicable

### BACKGROUND OF THE INVENTION

1. Field of the Invention

The present invention relates to a remote monitoring device and methods of using it and particularly relates to a crime-fighting remotely monitored camera system and the business method that makes it work.

2. Description of the Prior Art

Conventional police work and security systems attempt to stop crime in areas where criminals commit crimes. Criminals and their crimes can ruin an entire neighborhood, both for businesses and residences. Clearly, citizens and police forces want a safer place to live, work and play. Not only does crime affect every business and citizen, but the mere perception of crime also creates problems. In high crime areas, businesses are able to attract fewer customers, and neighborhoods are unable to house citizens who do not want to be subjected to crime.

Perhaps police officers have not accurately delivered the message that crime fighting is a collaborative effort between the police, citizens, and business owners. Although many volunteer groups exist in cities across the U.S., few of them are organized or managed toward a common goal. Police officers need to utilize technologies in more than a piecemeal format, rather what is needed is an interwoven consolidation model. Currently, it is believed that strategic planning is lacking for using technology in the most effective manner.

The initial question is why have crime camera programs been so ineffective. While crime locations have shifted after cameras were initially deployed, traditionally, there was not enough funding available to add additional crime cameras, or to move them as needed. New business methods of funding for enhancing crime camera programs is needed.

Although it is widely regarded that drug trafficking and street crimes will never be totally eradicated, it has been found that displacement of the criminal sites moves the crime away from those areas. Keeping criminals on the move and away from spots where they can be observed is very desirable. This is a classic example of the Displacement Theory. Crime displacement results in crime reduction at that particular spot.

However, traditional methods of crime displacement have included more and more police officers in squad cars to show a police presence. Wherever a police officer is, crime goes in the other direction to avoid getting caught. At a time when city budgets for most municipal groups are shrinking, there is less and less money to hire more police. Therefore, a police multiplier system would be most helpful.

In order to put together such a police multiplier and strategic crime reduction plan, principal anti-crime agencies need to have more and more police multiplier involvement and surveillance. In the past, attempts have been made to provide a police surveillance multiplier device. To help catch criminals, businesses and municipalities have instituted strategic placement of surveillance cameras and video recording devices connected to digital data collection points designed to catch criminals in the act.

However, those security cameras were not interconnected into a system that is effective in actually deterring crime. As these individual systems are not interconnected to a central monitoring location, the security cameras and their recorded data can only be reviewed after a crime has occurred, not while it is happening.

Moreover, it has been found that there is a severe lack of trust between our citizens, government leaders, and the police, especially among minority groups. Part of the problem is that there is a lack of transparency between our citizens, government leaders and police. Currently, we react to issues involving transparency and trust after riots and civil unrest occurs, rather than before, so switching to a data-driven/statistical model of policing instead of our reactionary style will make this model more accurate, and provide true information to the public, so they can understand police actions. This may alleviate some of the fear and distrust of the police, and may help to get more cooperation from the public in fighting crime.

Too little emphasis has been placed on the connection between crime, beautification programs, citizen involvement, and economic development. It would be most helpful if civilians, such as the Chamber of Commerce, DDA officials, investors, and businessmen could become more involved in crime prevention programs. It is well acknowledged that everything affects crime and crime affects everything.

Therefore, it would be a great advantage to crime-fighting agencies and citizens to have a system that is constantly being monitored for “real time” surveillance in order to stop crimes while they are happening. Further, it would be even more advantageous to have an interactive system that can deter crime as it is happening by the use of having “eyes” at the crime scene itself, with an optional ability to have vocal output with the suspect(s) committing the crime.

### SUMMARY OF THE INVENTION

The present invention provides a remote monitoring crime-fighting device that can be interconnected with sheriff departments, police departments and other municipalities to a crime camera video surveillance center to provide a unique crime reduction strategy that provides a unification of all resources that is a part of a total strategic crime-reduction plan. Instead of adding more and more police personnel, the present invention provides a police multiplier system of an “all seeing, all smelling, all hearing” technological advance for fighting crime. These high-tech crime-fighting devices act as a police multiplier. The present invention will be able to see what is going on at a particular location, hear it, sense it in many ways, as well as having optional analytics on board, including such things as facial recognition, bomb sniffing, shout out capability for a monitor back at the monitoring center to scream at potential criminals. After observing a criminal, if a monitor can contemporaneously shout out “Hey you, we know who you are and what you are doing!” it will go a long way to displace crime from that scene.

Just imagine if a monitor was sitting at his desk, observing 20 different live feed video screens covering various high crime intersections, and he saw a crime happening with a drug dealer in real time on one of his monitors. The facial recognition part of the crime-fighting device could be clicked on, and if the drug dealer was in the system, he could be recognized and identified. Then, while sitting miles away, safely at his monitoring desk, the monitor could use the speaker system of the crime-fighting device to shout out to the drug dealer down in the intersection. The monitor could say, “Hey Joe, you're caught . . . we're sending a man out to arrest you. Your drug deal has been recorded!” Wouldn't every criminal avoid that intersection now? Hopeful as that may be, one can never stop all crime. The most one can hope for is that it becomes displaced to a new location. Regardless, it would put a crimp in crime at that time and place.

In another aspect of the present invention, disclosed is a high-tech crime camera incorporating an optional “Video Push Feature” that allows any citizen to have an app on their phone with a surveillance icon that, when clicked on, turns their phone into a high-tech crime camera that will provide live feed back to the crime monitor at the police station. Citizens can quickly click on the icon and video record a crime scene image or video clip that will automatically be sent to the closest crime camera. Also, this invention envisions that such an app could also enable on-board video analytics capable of facial recognition, license plate recognition, abandoned package detection, wrong-way vehicle detection, fall detection, unlawful gathering detection, alarm activation detection, bomb detection, gunshot detection, bio-chemical detection, radiation detection, vehicle crash detection and other video analytic and security sensor integration, among other analytics commercially available.

In addition, methods of using the device and methods of doing business in supplying such devices to the municipalities is also disclosed. When a high-crime area is identified, especially in a place where there is little money for adding a high tech security solution, the present surveillance device would be most welcome. All crime activity can be monitored with live camera feeds to a centrally monitored location. The live camera feeds can be displayed on multiple monitor screens, so that a single police officer can monitor numerous geographic locations at once from a central location in the police department. This will reduce the number of physical police officers necessary to fight crime, while providing the same amount of “eyes” on the streets. By practicing the present invention, funding needed for law-enforcement technologies and programs to maximize police operations can be provided, as described in more detail hereinbelow.

In this aspect of the present invention, a new and novel business method provides funding to purchase the crime-fighting devices of the present invention. Municipalities and police agencies budgets will be augmented by using private and public funding for numerous remote monitoring devices and the central monitoring of those devices in order to move crime out of a particular area. This business method provides citizens and businesses the unique ability to partner with local police departments by donating money or purchasing a high-tech, remotely monitored, security camera unit which can then be donated to the city or municipality to be used in its crime-fighting efforts. The municipality will then own the remote monitoring camera unit. The citizen or business will then be provided a tax write-off for the donation. The municipality or police department will then be liable for maintaining and insuring the remote monitoring camera units. Consequently, any individual or local business desiring real time 24/7 monitoring can either purchase a remote monitoring device or donate funds to be used collectively to purchase a remote monitoring device for a particular high crime area, knowing that those individuals or local business owners will get round-the-clock police protection for a reasonable price.

This business method also includes a system for grant writers on staff to apply for state, federal and foundation grants to assist in funding these high-tech crime fighting technologies. In addition, the present invention discloses an optionally created website that allows citizens, businesses and others to donate money via the internet to pay for all high-tech crime fighting technologies as well as the associated costs to monitor these technologies. Private citizens and local business owners may find it advantageous to donate money for the crime fighting devices as an inexpensive way to fight crime at their homes or their businesses. Furthermore, practicing the present method would also include organizing and certifying all the volunteer groups toward the common goal of helping to reduce crime and increase economic development. Our experience shows that many individuals are eager to participate as volunteers after they have been background checked and certified. By utilizing highly trained and vetted volunteers in several areas, police efforts are complimented, acting as a force multiplier. By providing a trained crime analyst that gives law-enforcement leaders real-time crime data and public and/or suspect social media information, the police can what they do best, and our system can handle the peripheral issues.

In addition, sheriff departments across the country are allowed by law, to employ sheriff reserve deputies, where these individuals work for the various sheriff departments alongside sworn-in police officers from their department or sworn-in sheriff deputies, and thus are authorized to carry out law enforcement responsibilities. These reserve officers or sheriff deputies are able to lawfully monitor these crime fighting cameras and technologies at little or no cost as compared to using regular sworn police officers or sheriff deputies. Fully trained civilian monitors may be employed to monitor a large number of video screens while being overseen by a retired police officer or his equivalent. If a crime is detected, the volunteer would immediately alert the supervising retired police officer to the situation, and then the police would take over.

The name for this business method program is “Adopt A COP” and it is envisioned that once it is up and running in full force, all the video feeds from the street corners, or businesses, where the overt and covert security cameras have been installed, will be fed remotely into a secure commercial building, creating a video command center or an emergency response center where the video feeds are all fed into this building and recorded. These security cameras may then be monitored by the sheriff reserve deputies who volunteer their time, collectively on a twenty-four hour a day, seven days a week, three hundred and sixty five day per year basis.

This business method will provide a far more thorough and less expensive system than hiring numerous more police officers. On a yearly contractual basis, the savings will be great for the police departments or municipalities. My business staff will train the sheriff reserve deputies what to look for when watching the live or recorded video feeds. My company will also train these sheriff reserve deputies so they will know when to call a central dispatch to have a sworn, on-duty, sheriff deputy or police officer respond to the area where the sheriff reserve deputy is watching on the video feed. The sheriff deputy will make a determination from watching the video feed if the ongoing suspicious activity will warrant an actual police response to address a crime occurring at that moment or recently.

### BRIEF DESCRIPTION OF THE DRAWINGS

A more complete and full understanding of the aspects and nature of the present invention will become apparent upon considering the following detailed description, when taken in connection with the accompanying drawings, wherein:

FIG. 1 shows a first aspect of the invention which includes a remote monitoring device;

FIG. 2A shows yet another aspect of the present invention;

FIG. 2B shows a cutaway version of the remote monitoring device of FIG. 2A;

FIG. 3 illustrates yet another aspect of the present invention;

FIG. 4 is a side elevational view of the compact remote monitor of FIG. 3; and

FIG. 5 is a schematic diagram of the business method of the present invention.

### LIST OF REFERENCE NUMERALS UTILIZED IN THE DRAWINGS

10. Monitoring device
12. Box containment
12a. Box lid
14. Camera inside a lens cover
16. Blue flashing lights
18. Transmitter antenna
20. Warning lights
22. Latches
24. Handle
30. Transmitter box
32. DVR (Digital video recorder)
34. DVR data receiver
38. Camera lens
40. Compact remote monitor
42. Monitor cap
44. Monitor container
46. Camera dome
48. Camera lens
50. Transmitter wires

### DETAILED DESCRIPTION OF THE INVENTION

In accordance with the present invention, there is disclosed a crime-fighting remote monitoring device, methods for its use to multiply police presence to deter crime at particular locations, and a business method for raising funds to pay for the remote monitoring device and service the device to help deter crime in those areas.

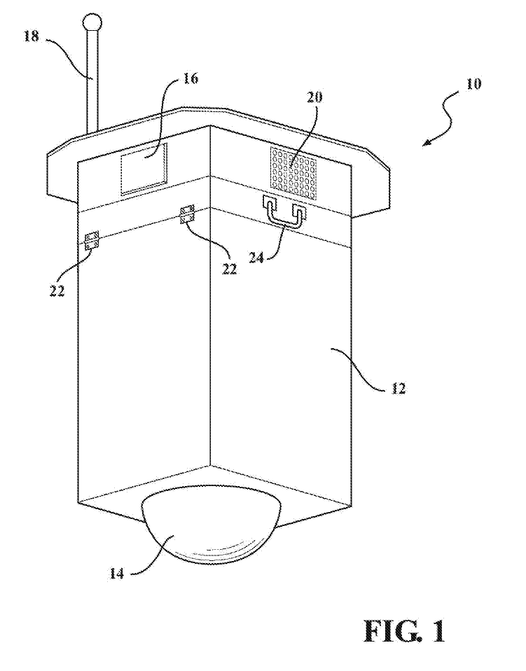

FIG. 1 shows a first aspect of the invention which includes a crime-fighting remote monitoring device generally denoted by numeral 10 including a box containment 12 with a box lid 12a. Box 12 includes a camera inside a lens cover 14 for surveilling areas of high crime. These boxes can be mounted on telephone poles and street lights and other places that can easily have a straight line of sight to high crime areas. They can either be permanently mounted or made into a portable unit such that it can be moved as the crime moves away from the original site.

As one can imagine, completely stopping crime is not entirely possible because criminals will always be intent on committing crimes and they will always commit crimes. However, with the devices made in accordance with the present invention, police and security officials can “displace” crime. Criminals will invariably move their crime activities initially to areas with less police presence, fewer security cameras, and less security programs that are in place. Therefore, it is imperative to keep moving the crime until it is moved entirely out of an area, and this may require moving the surveillance and remote monitoring devices as the crime is moved away from certain areas. Referring again to FIG. 1, in this aspect of the invention, a lighting system may be employed on top of the box including blue flashing lights 16 or warning lights 20. A transmitter 18 is preferably attached to the side or upper surface of the box in order to provide a live feed to a central monitoring location as described above. Box 12 may include latches 22 and a handle 24 in order to open the box for maintenance of the digital video recorder contained therein. It would be most advantageous if the box 12 and camera inside lens cover 14 is made of an anti-ballistic material because criminals will try to shoot the box and destroy the surveillance equipment inside.

Preferably, box containment 12 will be made of a formed plastic material having an anti-ballistic material, whether high strength steel, Kevlar, ceramic, or any other anti-ballistic material contained with the walls of box containment 12. Most preferably, the formed plastic material is a powder impression molded or rotomolded recycled material that encapsulates an anti-ballistic material. Further, the lens cover

[symbol]

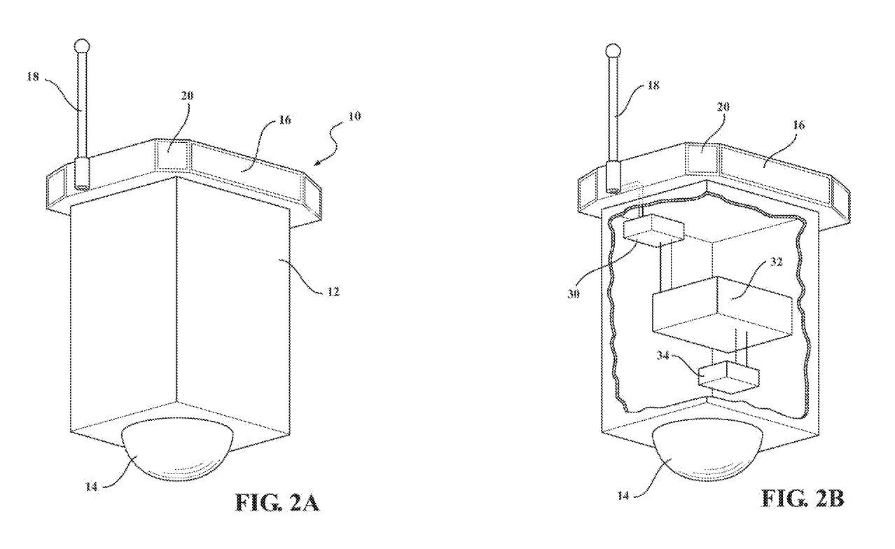

FIG. 2A shows yet another aspect of the present invention, wherein the remote monitoring device 10 includes a box containment 12 with a camera dome 14 extending there below. Again, blue flashing lights 16 and warning lights 20 can be remotely activated in order to deter a criminal from engaging in acts.

FIG. 2B shows a cutaway version of the remote monitoring device of FIG. 2A, and illustrates relative placement of a digital video recorder (DVR) in electrical communication with DVR data receiver 34 connected to camera 14. The information from DVR 32 is transmitted through a transmitter box 30 and transmitter antenna 18 to be viewed at a central monitoring location.

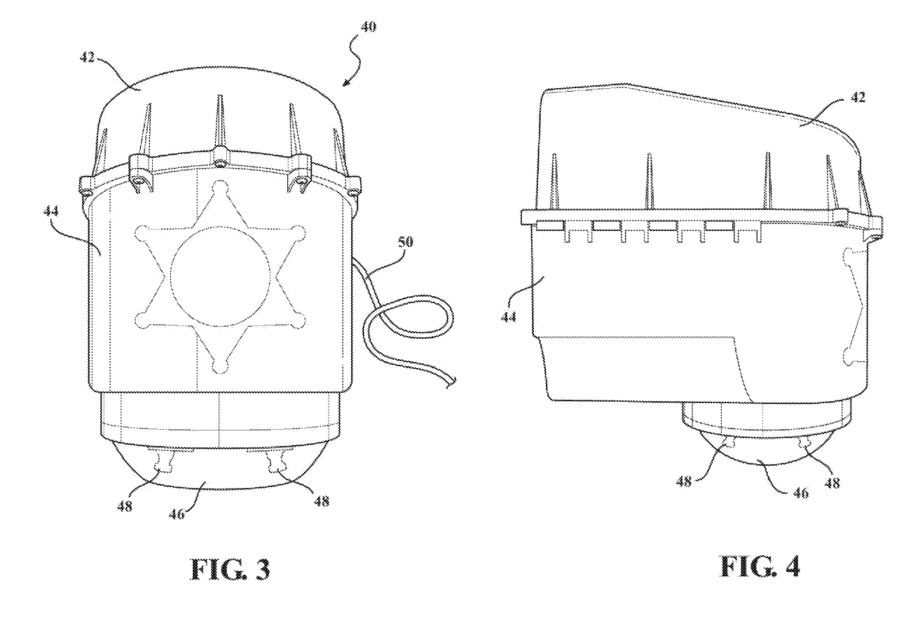

FIG. 3 illustrates yet another aspect of the present invention including a compact remote monitor 40 having a monitor cap 42 thereon top of a monitor container 44. The camera dome 46 extends from the bottom of it and is preferably made of a bullet-proof material in order to protect the camera lens 48. It would be common to mount this compact remote monitor up sufficiently high so that a criminal could not physically reach it to smash out the camera or destroy the compact remote monitor 40 itself. Transmitter wires 50 are in communication with the appropriate equipment for transmitting information to a central location.

FIG. 4 is a side elevational view of the compact remote monitor of FIG. 3 and shows the relative placement of monitor cap 42 and monitor container 44 with camera dome 46 extending below. Camera dome 46 can protect camera lens 48 from the elements and from criminal destruction.

It must be noted that any of the above described devices can be permanently mounted or be mounted onto a portable unit that can be moved once crime has been moved from a particular area to their new location.

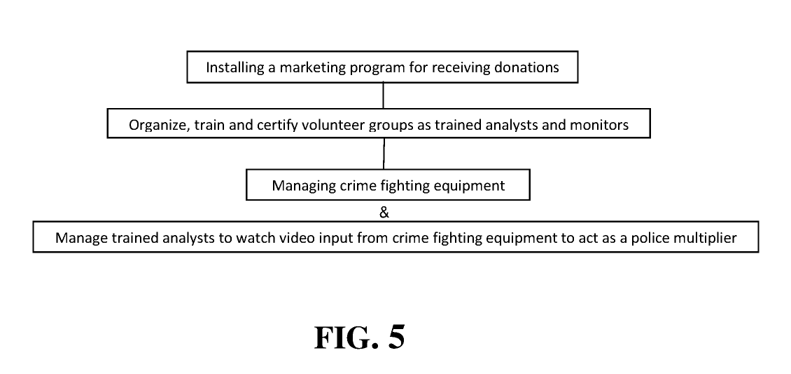

FIG. 5 is a schematic showing the preferred steps for the business method disclosed herein. In that regard, the present invention discloses a business method of fund raising and providing crime displacing and deterring equipment in a high crime area that includes installing a marketing program for receiving donations and accumulating those donation funds to purchase crime fighting equipment and paying for installing them. To concentrate the objectives of the crime fighting, it is advantageous to have a meeting with local citizens and businesses to ascertain their law enforcement issues and then design, implement and manage a community wide program to address those issues. We will provide trained and certified expert crime analysts to manage the crime fighting equipment and collectively manage the expert crime analysts to act as extra eyes and ears for law enforcement officers. By training and managing a central clearinghouse for a workforce of trained crime analysts, we will be providing monitors to observe the video outputs of the multiple live feeds from the crime fighting equipment to determine which video mandates a law enforcement officer be summoned to a crime scene as a crime is occurring.

The business method may include a set of setting up a 501(c)(3) tax free corporation for receiving donations. Also, providing grant writers to fill out grant applications for purchasing the crime-fighting equipment would be most helpful. Media relations for managing the business method, along with providing training for volunteers to certify them as certified expert crime watchers and responders will be most helpful. In furtherance of the method, engaging beautification services to clean up locations after crime has been displaced makes the prior crimes scenes to be less likely for that location to return to a crime area.

The scope of the invention provides for the sum total of the volunteers to be collectively managed to assist law enforcement officers per their requirements, as the crime analysts will provide crime statistics to the municipal or sheriff management team so that assessment of additional remote monitoring device security cameras can be added or moved as necessary. This will insure that as the crime moves, the sheriff or police departments can be responsive and address the crime shifts. A total management system of deploying and redeploying various police resources as the crime moves and dictates will be determined by the crime analyst in conjunction with the sheriff or police department. This will allow for the sheriff or police departments to run as efficiently as possible without duplication of police efforts.

In accordance with the present invention, a remote monitoring device for multiplying police presence includes at least one box containment having a video camera with a lens inside the box containment, where the video camera is adapted to be directed to a desired observation point. Inside the box is crime fighting equipment and either wired or wireless electronic communication is established between the crime fighting equipment and a remote audio video monitor, like at least one remotely located audio/video monitor for viewing the electronic communication by an authorized crime watcher, preferably a certified volunteer.

Because criminals might attempt to destroy the box containment, it is preferably made of anti-ballistic materials to protect the crime fighting equipment located therein from being shot and destroyed. Preferably, a motorized camera adjuster could be employed so that the authorized crime watcher can remotely adjust the position of the camera to capture the most advantageous angle. To provide a complete crime-fighting unit, many different types of analytics are also in electronic communication with the remote audio video monitor, usually on site at a sheriff's department.

Some of the most helpful analytics including video analytics capable of facial recognition, license plate recognition, abandoned package detection, wrong-way vehicle detection, unusual behavior detection, fall detection, unlawful gathering detection, alarm activation detection, bomb detection, gunshot detection, bio-chemical detection, radiation detection, law enforcement resource allocation based upon crime statistic analysis, vehicle crash detection and other video analytic and security sensor integration, and combinations thereof. An outside speaker for shouting out from the remote monitoring device is also helpful to let the criminals know that they are being viewed and recorded. Digital video recorders will be either on the pole for recording events, or at the sheriff's department, or at both locations. Transmitters from the pole mounted devices will relay electronic information to the monitoring station.

In another aspect of the present invention, a cellular phone app for providing an instantaneous audio video live feed to the remote monitor and digital video recorder will be offered to the public so that if a citizen witnesses a crime, they can just hit the icon on their phone, and it will provide live streaming video to the monitoring station. The video images will be recorded while it is being viewed by a monitor. In that manner, witnesses do not have to identify themselves, providing a great deal of support to the police departments instead of a “see something, say something” policy, which scares potential witnesses. Those citizens using their cell phones would not need to fear retaliation by the criminals, as the citizen doing the video do not need to be identified. The video record will speak for itself, and the witness might not need to testify in court.

In practicing the present method of remotely monitoring crime, the steps may include providing crime fighting equipment with at least a video camera and transmitting the video information from the video camera to capture the video live feed and necessary information from the crime fighting equipment. By placing the equipment on a pole near a high crime area, criminals are displaced. Thereafter, the crime-fighting equipment can be mounted on a mobile unit that can be moved once the criminals have been displaced. The volunteers and/or certified crime analysts will monitor at least one live video fee from the crime fighting equipment at a remote location with an authorized crime watcher, such as a law enforcement officer and the volunteers can alert the authorities when criminal activity is detected. As discussed above, a cellular telephone app can be downloaded by citizens and authorized crime watchers, wherein the cell phone app can be activated immediately by pressing an icon to provide live video feed back to a recorder. Such a cell phone app would essentially multiply law enforcement again many times over. Activating the cellular telephone app quickly records the images from the video and pushes criminal activity information to a secured server for preservation of evidence.

To further multiply the “eyes on criminals”, a local business or homeowner can register a pre-existing security system from a private citizen or a local business to tie it into the monitoring system of the present invention, in order to expand coverage, and to increase preserved records.

With current concerns about police shootings, the local citizenry use this mechanism for filing a report of a live phone video feed, filing a report about a complaint against a particular law enforcement personnel, an offensive municipal employee, or a report of blight in the community that needs to be beautified can be filed. As with any personnel, not all will be perfect, and it is in the best interests of any sheriff's department to know when bad cops are not acting right, so the problem can be addressed.

A new business method is disclosed in accordance with the present invention and includes basic steps of identifying where crime is, offering a funding program to locals and installing the remote monitoring devices so that there is an interactive video feed back to a central location to be monitored by either a sworn in police department, a volunteer or a sheriff reserve deputy that has been trained to review the video feeds. This business method will provide a crime analyst which will work closely with police agencies to keep crime patterns, shifting of crime from one geographic location to another and any other matter which needs to be closely watched at the video command center which will be owned and operated by the sheriff or municipality.

In practicing this business method of fund raising and providing crime displacing and deterring equipment in a high crime area, certain steps will be followed, including installing a marketing program for receiving donations, and accumulating donation funds generated by the marketing program to purchase crime fighting equipment and paying for installing them. Once a sufficient amount of funds has been raised, there will be a meeting with local citizens and businesses to ascertain their law enforcement issues. Then, we will design, implement and manage a community wide program to address those issues by providing trained and certified expert crime analysts. By managing the crime fighting equipment and collectively managing the expert crime analysts to act as extra eyes and ears for law enforcement officers, a “volunteer clearinghouse” can be established that the police will be able to tap into. Currently, we know of no centralized volunteer program where the police could contact and say, for example, “Can you send volunteers in marked cars to this outdoor concert and just show a presence”? This method provides training and managing a central clearinghouse for a workforce of trained crime analysts, some of which will act as monitors to observe the video outputs of the multiple live feeds from the crime fighting equipment to determine which video mandates a law enforcement officer be summoned to a crime scene as a crime is occurring, while others could just help law enforcement.

Further in accordance with the present business method invention, setting up a 501(c)(3) tax exempt corporation for receiving donations will encourage donations. In addition, grant writers can fill out grant applications for purchasing the crime-fighting equipment. Media relations may also be employed to manage the business method.

Law enforcement approved training programs for certifying volunteers as certified expert crime watchers and responders will be utilized to maintain top quality monitoring, while providing confidence in the public for these volunteer crime analysts. Collectively managing the volunteers can include many tasks. Since crime is less likely in beautiful settings, one such task that can be performed by some of the volunteers might include beautification services to clean up locations after crime has been displaced.

Lack of detailed crime analysis prevents quick responses to crime patterns at the present time, and it is envisioned by the present inventor that because criminals move from one police department's jurisdiction to another the crime reports being filed are currently decentralized. Therefore, police departments are not realizing that they have a problem coming in their direction until there are several similar crimes which alert them to the problem. In this aspect of the invention, all the information will be easily transmitted as it will already be in data format, and nearby police departments can be alerted to the moving crime patterns. The video command center concept can be expanded with minimal efforts to allow the security camera feeds from private businesses to be fed into and reviewed in either the live or playback mode from the command center. In the instance of terrorist attacks, and other critical events, such as a national disaster or terrorist takeovers, the command centers can take over the security cameras, alarms and access control systems from these private sites allowing the sites to be able to function remotely.

Currently, most critical infrastructure sites include security command centers, although when a critical situation occurs on that site, the on-site command center becomes too vulnerable to the attack and could be out of service. Any critical infrastructure site can then be controlled by the sheriff or police command center during a crisis situation. All security cameras could be reviewed, and alarms and building sensors could be monitored and all the doors could either be opened or closed electronically, to various institutions and or businesses.

It is envisioned that most advantageously, the above monitoring could be done by volunteer sheriff reserve deputies or business and private individuals that can be trained and certified. Businesses and home owners can donate funds to pay for any ancillary operating cost. Further, by implementing this program, the sheriff's department or other municipal group will be able to provide the most cost effective service available. Between the high tech remote monitoring device system and the program, they will act as a force multiplier to the various agencies providing law enforcement services and strategic critical response services.

In another aspect of the present invention for the business method, a municipality may be identified which would have three primary issues, ie high crime, low funding, and a desire for technological advances to enhance public safety. Once identified, the municipality can be approached regarding this complete security solution which is being offered by my company including an “Adopt A COP” program with device, a mobile command unit, and a partnership set up with non-profit organizations utilizing private funding either through grants or crowd funding to fund the project. The worst crime area in a city will be identified and the first “Adopt A COP” unit will be placed in that location and reduction of crime can be monitored. For example, the first one that we installed yielded a reduction of crime of ninety percent (90%) in the first two weeks. Obviously, the crime moved to another location, but if the crime can be continuously moved away, eventually the area will become crime free. Potentially, a local non-profit organization that has direct ties to the city government could be utilized, such as the local Chamber of Commerce or Economic Development Corporation. These groups can identify potential funding sources which may also include private, or corporate foundations as well as governmental grants that are available at the time for security funding.

A city may then pursue the establishment of an “Adopt A COP” system whereby citizens can also donate to pay for the cameras. The “Adopt A COP” program may collectively use some of the funds to enact a media blitz explaining the technology and how it will positively affect the lives of local citizens. There could be a “Paypal®” link on the city website where citizens could make tax-deductible donations in any increment to their city's project. All funds received through this program will be directed towards the purchase, installation and associated administrative costs for the “Adopt A COP” program. Furthermore, once a website has been developed and maintained to fund this and all related activities, the sheriff or police department reservists that have previously been trained help to solicit through a marketing campaign for additional men or women who would like to participate in the program utilizing police or sheriff reserves.

In conjunction with the sheriff or police departments, in accomplishing the steps of the present invention, all sheriff or police reserve deputies will be vetted and trained and will work closely with the media, businesses and citizens in a transparent manner for them to make donations and buy into the program. There will be a Citizen Oversight Committee similar to a Board of Directors and we will solicit a cross section of the populous to sit on the Board of Directors. A yearly contractual basis for my company will provide management of the program, sales and installation of crime camera units, removal, maintenance and relocation of crime camera units as deemed necessary, by the trained crime analyst, among other activities. We will provide a liaison between the sheriff or police departments, in capturing of the crime data and assisting with the security camera or security technology needs of the individual departments. We can provide a grant writer to seek state, federal and foundation grants to expand and fund any sheriff or police crime-reduction programs, emergency response programs, and homeland security terrorist observations and activities.

Therefore, this unique “Adopt A COP” program discloses a new and novel concept for raising money and providing unique crime-reduction strategies through collaborative partnerships between municipalities, businesses, and the citizenry. When a citizen or business donates to the “Adopt A Cop” program, their name or company logo will be proudly displayed on the unit alongside the sheriff's department or police department's logo. All donations being made will be handled through the sheriff or police department personnel and there will be strict accountability of all funds. My company will not have access to the established account and will not be responsible for management or tracking of the funds utilized for the program.

Further aspects of the present invention may include training of citizens to monitor cameras, where the sheriff or police chief can empower certain citizens of the municipality to help reduce crime by monitoring certain security cameras from their homes or businesses. A unique part of this program is allowing neighborhood block captains, or other trusted individuals, the ability to view and control certain security cameras. My company will train these individuals who are given permission to see and control these security cameras. These individuals will only be trained and allowed to view and control certain security cameras after passing a background check by the sheriff department or police department personnel. These individuals will not be allowed to make any system changes. They will only be allowed to view the cameras live and control the PTZ (Pan/Tilt/Zoom) camera. They will not be allowed to delete any camera footage. My company and the sheriff department or police department will maintain records and audit trails pertaining to camera usage to ensure the cameras are being used in a proper and legal manner. Any violation will result in revocation of the responsible parties' viewing privileges.

Historically, most cities that have security cameras only utilize them in a reactive mode. In other words after something happens they review the camera to see what occurred. My company's′ proactive approach to 21-century policing empowers citizens to see and report the crime as it is occurring. Since most police agencies do not have the manpower to utilize police resources for monitoring the cameras it makes perfect sense to empower the citizens and make them true partners in crime fighting.

Both my company and the sheriff or police chief, understand that crime affects everyone. As such, to address it properly, it is mandatory that crime fighting be approached in a collaborative effort as detailed above. In this program authorized citizens will be able to monitor the security cameras 24 hours a day, 7 days a week.

Upon seeing an illegal criminal activity or suspicious situation the citizens will be instructed to call their local sheriff or police department to provide them with an eye witness account of what just occurred. All citizens allowed viewing privileges will also be trained to fill out reports that will be sent to the sheriff or police department via email for review. These reports will document key events that are captured on the security cameras that may necessitate follow-up by sheriff department or police personnel. The citizens will be trained to know what normally requires immediate police response and what information can simply be sent via email for possible follow up or further investigation at a later time. My company will design as part of this program the reporting forms needed for this program.

My invention can also include monitoring of crime scenes when a citizen witnesses a crime as it is happening. The “Video Push Feature”, which can become an icon on a person's phone is disclosed that will allow any citizen to have a surveillance icon on their cellular phone that when clicked on their cellular telephone will turn it into a high-tech crime camera that can be instantly turned on to transmit the video image or video clip to my central crime camera center. Citizens can quickly click on the icon and video tape a crime scene image that will automatically be sent to the closest crime camera.

Also, this invention envisions the incorporation of on-board video analytics which is capable of facial recognition, license plate recognition and the like. The present invention discloses the use of any commercially available visual recognition system so that any camera, whether it is my company's permanently mounted system, our portable unit, or a citizen with a smartphone recording and sending real time video of an in-progress crime scene to the central crime camera. Such visual recognition analytics can identify known criminals, their vehicles, their license plate, or any other recognition system possible.

### Neighborhood Watch/Crime Causation Training/Police Deployment:

My company realizes that almost all of the camera systems being deployed in the United States today are being under-utilized or are ineffective at having any measurable long term difference in reducing crime. The main reason is because most municipalities deploy security cameras and hope for the best. What happens when this occurs is they simply displace the crime a few blocks away.

The difference to our approach is that the security cameras play an important part, but only a part in this program. My company and the sheriff departments or police departments utilizing our plan are providing a solution. We're not simply hanging security cameras in high-crime areas. Under our program security cameras will assist our efforts but will only be part of the program. Our goal is to create what is referred to as “An Atmosphere of Security”. The perception of crime is always worse than crime actually is. As part of this program my company will train the citizens and businesses to realize that virtually everything affects crime. When we deploy a COP (Camera On Patrol) unit into a neighborhood we'll work closely with the citizens to make sure the below concerns are addressed.
Drug houses are identified.
Vacant homes are boarded up.
Abandoned vehicles and trash is removed.
Neighborhood Watch Programs are established. (My company has three (3) Certified Michigan police officers on staff that are trained neighborhood watch officers that will assist in developing these).
Grass is kept cut in the neighborhood.
Neighborhood “safe” houses are established for youth to go to in an emergency.
Curfew laws are strictly enforced.
My company will consult with the sheriff or police chief to advise what police resources can be re-directed in high-crime areas. (Omnipresence of police whenever possible)

The effectiveness of this program in part will necessitate a change in the way policing is done. Historically police agencies operate in a reactive mode to crime fighting. Due to reduction in manpower it is necessary that we approach crime fighting in new and innovative ways.

It is key for police agencies and individual police officers to understand that the majority of crime, homicides, gang activity, etc. is drug related. In any neighborhood where violent crime is rampant drugs are at the core. It is imperative that all police officers realize that the drug business operates like any other business. The drug dealers supply a product (drugs) to a consumer who buys them. Our goal is to separate the buyers from the sellers. If the buyers can't sell their products they move their operation elsewhere. Another misconception is that the police stop crime. Police officers don't stop crime they displace it. In other words criminals will always commit crimes. They flourish and commit crimes where they are allowed to. Under our program the sheriff or police chief and my company are committed to ensuring criminals find another venue to conduct business.

### Operation Disruption:

Wherever these high-tech crime units are deployed an omnipresence of police presence and citizen involvement will be established. Under the direction of the sheriff or police chief when police officers are not tied up on calls they will be encouraged to saturate the high crime areas where the COP units are installed. When the criminals see the COP units mounted in high-crime areas they will undoubtedly move a few blocks away to sell their drugs or commit their illegal acts. When they do this we stay one step ahead of them and move with them. Mobile police vehicles, that are camera equipped, can also be deployed into the area to help push the criminals out of the area. My company will also install additional, smaller, movable, security cameras as the criminals move to another location or onto another corner to keep them moving out of the area. Eventually the criminals will move out of the area entirely to other areas less protected by the police and citizens. Remember the police do not stop crime they displace it. The goal of this program is to displace crime out of the city or municipality utilizing our program.

When officers have to write reports they will be encouraged to do so inside their patrol cars and will be encouraged to park in high crime areas with COP's units installed thus helping to create that omnipresence of police. Another key component to reducing crime in high crime areas is to separate the drug buyers from the drug sellers. A very effective method is to saturate the area with police traffic units or on-duty police officers that are not tied up on patrol. The officers should be directed to effect traffic stops in these areas. Most drug buyers know exactly where to go to purchase drugs and do so on a regular basis. These “drug hoods” flourish because of their reputation and the fact the police leave them alone or tolerate their existence. Saturated police patrol, and enough traffic stops on the buyers, causes the sellers a loss of income and eventually forces the sellers to seek other areas to sell their drugs.

### Media Assistance:

The media will be an intricate part of our program. In other cities we deployed these high-tech solutions in the media covered the project very well. The citizens were interviewed and wholeheartedly supported the project. My company will work closely with the sheriff or police chief to maximize the positive impact the media will have on this project by carefully strategizing how the media can help make this program a success.

### Sheriff's Inmate Work Crew/Incarceration Diversion Program:

My company will work closely with the local sheriff to recommend areas his work crew can work in and beneficial tasks they can do in targeted areas to help reduce crime. The manpower the sheriff's work crew can provide will be another integral part to making this program a success. My company's personnel will also meet with the local sheriff to see if there are ways of utilizing individuals sentenced to Diversion Programs instead of jail as a source of manpower to assist this crime reduction program.

### Program Evaluation: Pre/Post COP Deployment Crime Statistics:

My company will be conducting a pre and post analysis of crime in areas COP units are being deployed. This will help gauge the success of the program as a whole. After review of the data my company will make recommendations on any changes that need to be made.

Collaboration with Central Dispatch or Police Dispatch:

My company personnel will meet with central dispatch or police dispatch officials to discuss the idea and possibility of incorporating the COP units into the wireless infrastructure central dispatch or the police dispatch municipalities' utilize for their in-car police dispatching and report writing. My company's engineers, as well as central dispatch or police dispatch personnel, will explore this possibility. By interfacing our COP units with the laptops in the police cars any police car in the municipality would be able to watch live or recorded video from any COP unit inside their jurisdiction. The possibility also exists that in addition to this any police car in the municipality could access any security cameras installed in any school or business in their jurisdiction. Utilizing this technology would be extremely beneficial during a crisis situation and would help keep the officers on the streets responding to critical situations safer.

### Zero-Tolerance to Curfew Violations:

Under our program we will encourage the sheriff or police departments to take a zero-tolerance approach to curfew violations. This will yield very measurable/positive results in the sheriff's or police chief's efforts at reducing crime in their jurisdiction. As part of this program a zero-tolerance approach to these types of violations will be embraced and strictly enforced. In areas these units are deployed special attention will be given to make sure curfew violations are addressed. These actions will undoubtedly reduce violent crimes that are happening to our youth. In addition we will see a reduction in property damage, vandalism, alcohol and drug use, larceny and drug-dealing.

The foregoing description of a preferred aspect of the invention has been presented for purposes of illustration and description. It is not intended to be exhaustive or to limit the invention to the precise form disclosed. Obvious modifications or variations are possible in light of the above teachings with regards to the specific aspects. The aspect was chosen and described in order to best illustrate the principles of the invention and its practical applications to thereby enable one of ordinary skill in the art to best utilize the invention in various aspects and with various modifications as are suited to the particular use contemplated.

What is claimed is:

1. A remote monitoring device for multiplying police presence, comprising:
a box containment having a video camera with a lens inside the box containment, said video camera being adapted to be directed to a desired observation point;
crime fighting equipment located within the box containment;
electronic communication between the crime fighting equipment and a remote audio video monitor; and
at least one remotely located audio/video monitor for viewing the electronic communication by an authorized crime watcher.

2. The remote monitoring device for multiplying police presence of claim 1, wherein the box containment is made of anti-ballistic materials to protect the crime fighting equipment located therein from being shot and destroyed.

3. The remote monitoring device for multiplying police presence of claim 1, further comprising crime-fighting analytics in electronic communication with the remote audio video monitor at a sheriff's department.

4. The remote monitoring device for multiplying police presence of claim 3, further comprising analytics including video analytics capable of facial recognition, license plate recognition, abandoned package detection, wrong way vehicle detection, unusual behavior detection, fall detection, unlawful gathering detection, alarm activation detection, bomb detection, gunshot detection, bio-chemical detection, radiation detection, law enforcement resource allocation based upon crime statistic analysis, vehicle crash detection and other video analytic and security sensor integration, and combinations thereof.

5. The remote monitoring device for multiplying police presence of claim 1, further comprising an outside speaker for shouting out of the remote monitoring device.

6. The remote monitoring device for multiplying police presence of claim 1, further comprising a digital video recorder for recording events.

7. The remote monitoring device for multiplying police presence of claim 1, further comprising a transmitter to relay electronic information to the monitoring station.

8. The remote monitoring device for multiplying police presence of claim 1, further comprising a cellphone app for providing an instantaneous audio video live feed to the remote monitor and digital video recorder.

9. The remote monitoring device for multiplying police presence of claim 1, further comprising a motorized camera adjuster whereby the authorized crime watcher can remotely adjust the position of the camera to capture the most advantageous angle.

10. A method of remotely monitoring crime, comprising:
providing crime fighting equipment with at least a video camera;
transmitting information from the video camera;
capturing video live feed and necessary information from the crime fighting equipment;
monitoring at least one live video fee from the crime fighting equipment at a remote location with an authorized crime watcher; and
alerting the authorities when criminal activity is detected.

11. The method of remotely monitoring crime of claim 10, further comprising providing a cell phone app to be downloaded by citizens and authorized crime watchers, wherein the cell phone app can be activated immediately by pressing an icon to provide live video feed back to a recorder.

12. The method of remotely monitoring crime of claim 11, wherein activating the cell phone app quickly records the images from the video and pushes criminal activity information to a secured server for preservation of evidence.

13. The method of remotely monitoring crime of claim 10, further comprising registering an existing security system from a private citizen or a local business in order to expand coverage of preserved records.

14. The method of remotely monitoring crime of claim 10, further comprising providing a mechanism for filing a report of a live phone video feed, filing a report about a complaint against law enforcement personnel or municipal employees, or filing a report of blight in the community that needs to be beautified.

15. The method of remotely monitoring crime of claim 10, wherein the step of providing crime fighting equipment is accomplished by placing the equipment on a pole near a high crime area or placing the crime-fighting equipment on a mobile unit that can be moved once the criminals have been displaced.

16. A business method of fund raising and providing crime displacing and deterring equipment in a high crime area, comprising:
installing a marketing program for receiving donations;
accumulating donation funds to purchase crime fighting equipment and paying for installing them;
meeting with local citizens and businesses to ascertain their law enforcement issues;
designing, implementing and managing a community wide program to address those issues;
providing trained and certified expert crime analysts;
managing the crime fighting equipment and collectively managing the expert crime analysts to act as extra eyes and ears for law enforcement officers; and
training and managing a central clearinghouse for a workforce of trained crime analysts, some of which will act as monitors to observe the video outputs of the multiple live feeds from the crime fighting equipment to determine which video mandates a law enforcement officer be summoned to a crime scene as a crime is occurring.

17. The business method of claim 16, further comprising setting up a 501(c)(3) tax free corporation for receiving donations.

18. The business method of claim 16, further comprising providing grant writers to fill out grant applications for purchasing the crime-fighting equipment.

19. The business method of claim 16, further comprising providing media relations to manage the business method.

20. The business method of claim 16, further providing training for volunteers to certify them as certified expert crime watchers and responders.

21. The business method of claim 16, further providing beautification services to clean up locations after crime has been displaced.

22. The business method of claim 20, wherein the sum total of the volunteers are collectively managed to assist law enforcement officers per their requirements.
